(19) United States
(12) Patent Application Publication
(10) Pub. No.: US 2025/0223426 A1
(43) Pub. Date: Jul. 10, 2025

(54) RESIN COMPOSITION, METHOD FOR PRODUCING SAME AND UNCROSSLINKED RESIN COMPOSITION

(71) Applicant: The Yokohama Rubber Co., LTD., Kanagawa (JP)

(72) Inventors: Kenta WAKABAYASHI, Kanagawa (JP); Miyuki NISHI, Kanagawa (JP)

(21) Appl. No.: 18/850,923

(22) PCT Filed: Dec. 12, 2022
(86) PCT No.: PCT/JP2022/045679

§ 371 Date: Sep. 25, 2024

(30) Foreign Application Priority Data
Mar. 30, 2022 (JP) 2022-056489
Sep. 29, 2022 (JP) 2022-156953
Sep. 29, 2022 (JP) 2022-157013

(51) Int. Cl. C08L 9/00; B29C 35/02; B29C 48/00; B29C 48/395; B29K 9/00; B29K 96/02

(52) U.S. Cl. CPC C08L 9/00; B29C 35/02; B29C 48/022; B29C 48/397; B29K 2009/00; B29K 2096/02; B29K 2995/0069; B29K 2995/0077; C08L 2205/03

(57) ABSTRACT

A resin composition contains elastomer having a polyisobutylene backbone and silane-modified resin. A content of the elastomer having a polyisobutylene backbone is 30 mass % or more and 90 mass % or less with respect to a mass of the resin composition. A content of the silane-modified resin is 10 mass % or more and 70 mass % or less with respect to the mass of the resin composition. A water vapor permeability of the resin composition is 2.0 g·mm/(m²·24 h) or less. A ratio TB₁₀₀/TB₂₅ of a strength at break TB₁₀₀ of the resin composition at 100° C. to a strength at break TB₂₅ of the resin composition at 25° C. is 0.2 or more and 1.0 or less.

### TECHNICAL FIELD

The present technology relates to a resin composition, a method for producing the same, and an uncrosslinked resin composition. The present technology more particularly relates to a resin composition having excellent flexibility, heat resistance, and water vapor barrier properties that can be used for production of a refrigerant-transporting hose used for an air conditioner of an automobile, a method for producing the same, and an uncrosslinked resin composition.

### BACKGROUND ART

With the increasing demand for weight reduction in automobiles, efforts have been made to achieve the weight reduction by producing a hose that has been used for automobiles and is made of rubber with resin having high barrier properties in place of rubber to reduce thickness. In particular, the hose for refrigerant transportation for current automobile air conditioners is composed mainly of rubber, and if the main material can be substituted with resin having high barrier properties, weight reduction can be achieved.

Japan Unexamined Patent Publication No. H04-145284 A describes a hose for transportation of a refrigerant such as Freon gas, an outer tube of the hose being made of a thermoplastic elastomer containing thermoplastic polyolefin resin and EPDM (ethylene propylene diene terpolymer) or butyl rubber.

Air conditioners of automobiles and the like are installed in limited, narrow spaces in automobiles, and thus excellent flexibility and easy installation even in narrow spaces are required for hoses for refrigerant transportation. Permeation of water vapor from a hose outer side causes freezing of moisture inside an air conditioner, and thus a material forming an outer tube of the hose for refrigerant transportation is required to have excellent water vapor barrier properties. Furthermore, the hose for refrigerant transportation needs to be durable enough to withstand long-term use in the high-temperature and high-humidity environment inside an engine room.

However, because a thermoplastic elastomer constituting an outer tube of a resin hose described in Japan Unexamined Patent Publication No. H04-145284 A contains thermoplastic polyolefin resin, heat resistance is not necessarily sufficient.

### SUMMARY

An object of the present technology is to provide a resin composition that can be used for producing an outer tube of a resin hose and that has excellent flexibility, water vapor barrier properties, and heat resistance.

An embodiment of the present technology (I) is a resin composition containing elastomer having a polyisobutylene backbone and silane-modified resin. A content of the elastomer having a polyisobutylene backbone is 30 mass % or more and 90 mass % or less with respect to a mass of the resin composition. A content of the silane-modified resin is 10 mass % or more and 70 mass % or less with respect to the mass of the resin composition. A water vapor permeability of the resin composition is 2.0 g·mm/(m²·24 h) or less. A ratio TB_{100/}TB₂₅ of a strength at break TB₁₀₀ of the resin composition at 100° C. to a strength at break TB₂₅ of the resin composition at 25° C. is 0.2 or more and 1.0 or less.

An embodiment of the present technology (II) is a method for producing the resin composition of the embodiment of the present technology (I). The method includes: preparing an uncrosslinked resin composition by melt-kneading elastomer having a polyisobutylene backbone and silane-modified resin: and adding a silanol condensation catalyst to an uncrosslinked resin composition during molding to mold the uncrosslinked resin composition. An embodiment of the present technology (III) is an uncrosslinked resin composition containing elastomer having a polyisobutylene backbone and silane-modified resin. A content of the elastomer having a polyisobutylene backbone is 30 mass % or more and 90 mass % or less with respect to a mass of the uncrosslinked resin composition. A content of the silane-modified resin is 10 mass % or more and 70 mass % or less with respect to the mass of the uncrosslinked resin composition. A water vapor permeability after the uncrosslinked resin composition is crosslinked is 2.0 g·mm/(m²·24 h) or less.

The present technology includes the following embodiments.
[1] A resin composition containing elastomer having a polyisobutylene backbone and silane-modified resin,
   a content of the elastomer having a polyisobutylene backbone being 30 mass % or more and 90 mass % or less with respect to a mass of the resin composition,
   a content of the silane-modified resin being 10 mass % or more and 70 mass % or less with respect to the mass of the resin composition,
   a water vapor permeability of the resin composition being 2.0 g·mm/(m²·24 h) or less, and
   a ratio TB₁₀₀/TB₂₅ of a strength at break TB₁₀₀ of the resin composition at 100° C. to a strength at break TB₂₅ of the resin composition at 25° C. being 0.2 or more and 1.0 or less.
[2] The resin composition according to [1], where the silane-modified resin is resin obtained by modifying polyolefin-based thermoplastic resin with a silane compound.
[3] The resin composition according to [1] or [2], where the silane-modified resin is silane-modified polypropylene.
[4] The resin composition according to any one of [1] to [3], where the resin composition contains a silanol condensation catalyst.
[5] The resin composition according to any one of [1] to [4], where the elastomer having a polyisobutylene backbone is butyl rubber or modified butyl rubber.
[6] The resin composition according to any one of [1] to [5], where the elastomer having a polyisobutylene backbone is dynamically crosslinked.
[7] The resin composition according to any one of [1] to [6], where the resin composition contains 1 mass % or more and 4 mass % or less of an anti-aging agent with respect to the mass of the resin composition.
[8] The resin composition according to any one of [1] to [7], where the resin composition has an islands-in-the-sea structure composed of a matrix containing the silane-modified resin and a domain containing the elastomer having a polyisobutylene backbone dispersed in the matrix, and the matrix is crosslinked.
[9] A method for producing the resin composition according to any one of [1] to [8], the method including:
   preparing an uncrosslinked resin composition by melt-kneading elastomer having a polyisobutylene backbone and silane-modified resin; and
   adding a silanol condensation catalyst to an uncrosslinked resin composition during molding to mold the uncrosslinked resin composition.

[10] The method according to [9] further including
after the step of adding a silanol condensation catalyst to an uncrosslinked resin composition during molding to mold the uncrosslinked resin composition, producing a crosslinked resin composition by bringing the uncrosslinked resin composition molded into contact with water or water vapor.
[11] An uncrosslinked resin composition containing elastomer having a polyisobutylene backbone and silane-modified resin,
   a content of the elastomer having a polyisobutylene backbone being 30 mass % or more and 90 mass % or less with respect to a mass of the uncrosslinked resin composition,
   a content of the silane-modified resin being 10 mass % or more and 70 mass % or less with respect to the mass of the uncrosslinked resin composition, and
   a water vapor permeability after the uncrosslinked resin composition is crosslinked being 2.0 g·mm/(m²·24 h) or less.
[12] The uncrosslinked resin composition according to [11], where after the uncrosslinked resin composition is crosslinked, a ratio TB₁₀₀/TB₂₅ of a strength at break TB₁₀₀ at 100° C. to a strength at break TB₂₅ at 25° C. is 0.2 or more and 1.0 or less.

The resin composition of an embodiment of the present technology has excellent flexibility, water vapor barrier properties, and heat resistance.

### DETAILED DESCRIPTION

The resin composition of an embodiment of the present technology contains elastomer having a polyisobutylene backbone and silane-modified resin.

The elastomer having a polyisobutylene backbone is not limited as long as the elastomer has a polyisobutylene backbone but is preferably butyl rubber (IIR), modified butyl rubber, or a styrene-isobutylene-styrene block copolymer, and is more preferably butyl rubber or modified butyl rubber.

The polyisobutylene backbone refers to a chemical structure formed by polymerization of a plurality of isobutylene, that is, a chemical structure represented by —[—CH₂—C(CH₃)₂·]ₙ— (however, n is an integer of 2 or more).

The butyl rubber refers to an isobutylene-isoprene copolymer obtained by copolymerizing isobutylene and a small amount of isoprene and is abbreviated as IIR.

The modified butyl rubber refers to butyl rubber, in which a double bond, a halogen, and the like are present in an isoprene backbone. As the modified butyl rubber, a halogenated butyl rubber is preferred, a brominated butyl rubber and a chlorinated butyl rubber are more preferred, and a brominated butyl rubber is even more preferred.

A styrene-isobutylene-styrene block copolymer is abbreviated as SIBS.

Because the resin composition contains the elastomer having a polyisobutylene backbone, flexibility and water vapor barrier properties of the resin composition are improved.

The elastomer having a polyisobutylene backbone is preferably dynamically crosslinked. The dynamic crosslinking improves durability. The content of the elastomer having a polyisobutylene backbone is 30 mass % or more and 90 mass % or less, preferably 40 mass % or more and 89 mass % or less, and more preferably 50 mass % or more and 88 mass % or less, with respect to the mass of the resin composition. When the content of the elastomer having a polyisobutylene backbone is too small, flexibility cannot be ensured. When the content is too large, extrudability deteriorates.

The resin composition contains silane-modified resin. The resin composition achieves improved heat resistance because the resin composition contains silane-modified resin.

The silane-modified resin refers to resin modified with a silane compound. The silane-modified resin is preferably resin obtained by modifying polyolefin-based thermoplastic resin with a silane compound, and is more preferably crosslinkable resin having a hydrolyzable silyl group (preferably an alkoxysilyl group) obtained by modifying polyolefin-based thermoplastic resin with a silane compound, or crosslinked resin obtained by crosslinking the crosslinkable resin.

The silane compound is not limited but is preferably a compound represented by Formula (1).

R¹—SiR²ₙY₃₋ₙ (1)

R¹ is an ethylenic unsaturated hydrocarbon group, R² is a hydrocarbon group, Y is a hydrolyzable organic group, and n is an integer of 0 to 2.

R¹ is preferably an ethylenic unsaturated hydrocarbon group having from 2 to 10 carbons, and examples thereof include a vinyl group, a propenyl group, a butenyl group, a cyclohexenyl group, and a γ-(meth) acryloyloxypropyl group.

R² is preferably a hydrocarbon group having from 1 to 10 carbons, and examples thereof include a methyl group, an ethyl group, a propyl group, a decyl group, and a phenyl group.

Y is preferably a hydrolyzable organic group having from 1 to 10 carbons, and examples thereof include an alkoxy group (e.g., a methoxy group, an ethoxy group), a formyloxy group, an acetoxy group, a propionyloxy group, an alkyl amino group, and an arylamino group.

Specific examples of the silane compound include vinyltrimethoxysilane, vinyltriethoxysilane, vinyltriacetoxysilane, and γ-methacryloyloxypropyltrimethoxysilane. Among these, vinyltrimethoxysilane is preferred.

The polyolefin-based thermoplastic resin constituting the silane-modified resin is not limited, and examples thereof include polyethylene, a copolymer of ethylene and α-olefin, polypropylene, and a copolymer of propylene and another α-olefin. Polypropylene and a copolymer of propylene and another α-olefin are preferred, and polypropylene is particularly preferred.

The hydrolyzable silyl group refers to a group generating a silanol group (═Si—OH) by hydrolysis and is preferably a group represented by Formula (2).

—SiR²ₙY₃₋ₙ (2)

However, R² and Y are as described above.

The crosslinkable resin refers to resin that can undergo a crosslinking reaction but that is not crosslinked yet. The crosslinked resin refers to resin formed by crosslinking the crosslinkable resin. The type of crosslinking reaction is not limited and may be a crosslinking by a peroxide but is preferably a crosslinking by moisture (water crosslinking).

The method of modifying with a silane compound is not limited and examples thereof include grafting and copolymerization. The grafting is a method of adding a silane compound to resin by a grafting reaction and is more specifically a reaction of generating a carbon radical by cleaving a carbon-hydrogen bonding of polyolefin and adding a silane compound having an ethylenic unsaturated hydrocarbon group to the carbon radical. The modification can be preferably performed by melt-kneading resin and a silane compound of Formula (1) in the presence of a radical generator, such as an organic peroxide. The copolymerization can be preferably performed by radical copolymerization of a monomer constituting resin and a silane compound of Formula (1).

The silane-modified resin is preferably silane-modified polypropylene. The silane-modified resin is commercially available, and a commercially available product can be used as silane-modified resin used for an embodiment of the present technology. Examples of the commercially available product of the silane-modified resin include “Linklon” (trade name) available from Mitsubishi Chemical Corporation.

The content of the silane-modified resin is 10 mass % or more and 70 mass % or less, preferably 11 mass % or more and 60 mass % or less, and more preferably 12 mass % or more and 50 mass % or less, with respect to the mass of the resin composition. When the content of the silane-modified resin is too small, extrudability becomes poor. When the content is too large, flexibility cannot be ensured.

The resin composition may contain resin other than the silane-modified resin. Examples of the resin other than the silane-modified resin include polyolefin resin and polyamide resin. Examples of the polyolefin resin include polypropylene. Blending of the polypropylene in addition to the silane-modified resin forms a phase structure that tends to exhibit strength during heating because the viscosity of the resin component becomes stable. Furthermore, because the water vapor barrier properties of the polypropylene are good, the water vapor barrier properties of the entire composition become good.

In a case where the resin composition contains resin other than the silane-modified resin, the content of the resin other than the silane-modified resin is preferably 1 mass % or more and 60 mass % or less, more preferably 2 mass % or more and 55 mass % or less, and even more preferably 3 mass % or more and 50 mass % or less, with respect to the mass of the resin composition.

The water vapor permeability of the resin composition is 2.0 g·mm/(m²·24 h) or less, and preferably 1.9 g·mm/(m²·24 h) or less.

When the water vapor permeability is within the numerical range described above, flexibility and water vapor barrier properties can be provided in a compatible manner.

The water vapor permeability is measured at a temperature of 60° C. and a relative humidity of 95% by using a water vapor permeability tester.

The resin composition has a ratio TB₁₀₀/TB₂₅ of the strength at break TB₁₀₀ at 100° C. to the strength at break TB₂₅ at 25° C. of 0.2 or more and 1.0 or less, preferably 0.3 or more and 1.0 or less, and more preferably 0.35 or more and 1.0 or less. When the TB₁₀₀/TB₂₅ is closer to 1.0, better heat resistance is achieved. By crosslinking of the silane-modified resin, the TB₁₀₀/TB₂₅ falls within the numerical range described above, and heat resistance is improved.

The strength at break can be measured in accordance with the measurement method specified in JIS (Japanese Industrial Standard) K 6251 “Rubber, vulcanized or thermoplastics-Determination of tensile stress-strain properties”.

The resin composition preferably contains a silanol condensation catalyst. When the silanol condensation catalyst is contained, crosslinking of the silane-modified resin is promoted.

Examples of the silanol condensation catalyst include, but not limited to, a metal organic acid salt, a titanate, a borate, an organic amine, an ammonium salt, a phosphonium salt, an inorganic acid, an organic acid, an inorganic acid ester, and a bismuth compound.

Examples of the metal organic acid salt include, but not limited to, dibutyltin dilaurate, dioctyltin dilaurate, dibutyltin diacetate, dibutyltin dioctoate, tin(II) acetate, tin(II) octanoate, cobalt naphthenate, lead octylate, lead naphthenate, zinc octylate, zinc caprylate, iron 2-ethylhexanoate, iron octylate, and iron stearate.

Examples of the titanate include, but not limited to, tetrabutyl titanate, tetranonyl titanate, and bis(acetylacetonitrile) di-isopropyl titanate.

Examples of the organic amine include, but not limited to, ethylamine, dibutylamine, hexylamine, triethanolamine, dimethyl soya amine, tetramethylguanidine, and pyridine.

Examples of the ammonium salt include, but not limited to, ammonium carbonate and tetramethylammonium hydroxide.

Examples of the phosphonium salt include, but not limited to, tetramethylphosphonium hydroxide.

Examples of the inorganic acid include, but not limited to, sulfuric acid and hydrochloric acid.

Examples of the organic acid include, but not limited to, acetic acid, stearic acid, maleic acid, toluenesulfonic acid, and sulfonic acid such as alkylnaphthylsulfonic acid. Examples of the inorganic acid ester include, but not limited to, a phosphoric acid ester.

Examples of the bismuth compound include, but not limited to, an organic bismuth such as bismuth 2-ethylhexanoate.

The silanol condensation catalyst is preferably a metal organic acid salt, sulfonic acid, or a phosphoric acid ester, and more preferably a metal carboxylate of tin such as dioctyltin dilaurate, alkylnaphthylsulfonic acid, and ethylhexyl phosphate. One type of silanol condensation catalyst may be used alone, or two or more types of the silanol condensation catalysts may be appropriately combined and used.

The content of the silanol condensation catalyst is not particularly limited but is preferably from 0.0001 to 0.5 parts by mass, and more preferably from 0.0001 to 0.3 parts by mass, with respect to 100 parts by mass of the silane-modified resin.

The silanol condensation catalyst is preferably used as a silanol condensation catalyst-containing master batch in which resin and a silanol condensation catalyst are blended. Examples of the resin that can be used for this silanol condensation catalyst-containing master batch include a polyolefin, and a polyethylene, a polypropylene, and a copolymer of these are preferred.

In a case where the silanol condensation catalyst is used as a silanol condensation catalyst-containing master batch in which resin and a silanol condensation catalyst are blended, the content of the silanol condensation catalyst in the master batch is preferably, but not limited to, from 0.1 to 5.0 mass %. A commercially available product may be used as the silanol condensation catalyst-containing master batch, and for example, “PZ010”, available from Mitsubishi Chemical Corporation, can be used.

The resin composition preferably contains an anti-aging agent. When the anti-aging agent is contained, extrusion moldability becomes good.

Examples of the anti-aging agent include, but not limited to, a hindered phenol-based antioxidant, a phenol-based antioxidant, an amine-based antioxidant, a phosphorus-based heat stabilizer, a metal deactivator, and a sulfur-based heat resistant stabilizer, and a hindered phenol-based antioxidant is preferred, and a hindered phenol-based antioxidant having a pentaerythritol ester structure is more preferred. Specific examples of the hindered phenol-based antioxidant include IRGANOX (trade name) 1010 (pentaerythritol tetrakis[3-(3,5-di-tert-butyl-4-hydroxyphenyl)propionate]), available from BASF Japan Ltd.

The content of the anti-aging agent is preferably I mass % or more and 4 mass % or less, and more preferably 1 mass % or more and 3.5 mass % or less, with respect to the mass of the resin composition.

The resin composition can contain elastomer other than the elastomer having a polyisobutylene backbone, resin other than the silane-modified resin, and an additive other than the silanol condensation catalyst and the anti-aging agent in a range that does not impair the effect of the present technology.

The resin composition may have any phase structure but preferably has an islands-in-the-sea structure or a co-continuous structure, and more preferably has an islands-in-the-sea structure composed of a matrix (sea phase) containing silane-modified resin and a domain (island phase) containing elastomer having a polyisobutylene backbone dispersed in the matrix, where the matrix is crosslinked. The crosslinking of the matrix contributes to heat resistance. In a case of the co-continuous structure, excellent flexibility is achieved.

The method for producing the resin composition is not limited but preferably includes: preparing an uncrosslinked resin composition by melt-kneading elastomer having a polyisobutylene backbone and silane-modified resin; and adding a silanol condensation catalyst to an uncrosslinked resin composition during molding to mold the uncrosslinked resin composition.

The preparing an uncrosslinked resin composition by melt-kneading elastomer having a polyisobutylene backbone and silane-modified resin may be also simply referred to as “melt-kneading process” below.

The melt-kneading is not limited but may be performed by using a kneader, a single screw or twin screw extruder, or the like.

The temperature during the melt-kneading is not limited as long as the melt-kneading can be performed but is preferably from 170 to 240° C.

The time for the melt-kneading is not limited as long as the target kneaded material can be prepared but is preferably from 2 to 10 minutes.

In the melt-kneading process, the elastomer having a polyisobutylene backbone and the silane-modified resin and, optionally, various additives such as an anti-aging agent are charged in a kneader or the like and melt-kneaded.

However, the silanol condensation catalyst is preferably not added in the melt-kneading process. In a case where the silanol condensation catalyst is added in the melt-kneading process, when the uncrosslinked resin composition prepared in the melt-kneading process is brought into contact with water vapor in the atmosphere, the silane-modified resin in the resin composition gradually crosslinks, and molding of the resin composition after the crosslinking becomes difficult. Therefore, the silanol condensation catalyst is preferably added to the uncrosslinked resin composition during molding.

The step of adding a silanol condensation catalyst to an uncrosslinked resin composition during molding to mold the uncrosslinked resin composition is also simply referred to as “silanol condensation catalyst addition and molding process”.

“During molding” refers to simultaneously with the molding or within 6 hours prior to the molding.

Examples of the molding include, but not limited to, extrusion molding and injection molding, and extrusion molding is preferred. The extrusion molding can be performed by, but not limited to, using an extruder and preferably performed by using a single screw extruder.

The silanol condensation catalyst may be added to the uncrosslinked resin composition before charging the composition into the extruder, the uncrosslinked resin composition and the silanol condensation catalyst may be charged into the extruder at the same time, or the uncrosslinked resin composition and the silanol condensation catalyst may be charged into separate feeding ports of the extruder.

The silanol condensation catalyst may be directly added to the uncrosslinked resin composition but is preferably added as a silanol condensation catalyst-containing master batch, in which resin and a silanol condensation catalyst are blended.

The conditions of the molding are not limited as long as the target molded product can be formed.

The method for producing the resin composition preferably includes, after the step of adding a silanol condensation catalyst to an uncrosslinked resin composition during molding to mold the uncrosslinked resin composition, producing a crosslinked resin composition by bringing the uncrosslinked resin composition molded into contact with water or water vapor (hereinafter, also simply referred to as “water contact process”).

When the uncrosslinked resin composition molded by the silanol condensation catalyst addition and molding process is brought into contact with water vapor in the air, the silane-modified resin in the composition gradually crosslinks and forms a crosslinked resin composition: however, when rapid production of a crosslinked resin composition is desired, the water contact process is preferably performed.

Examples of the method of bringing into contact with water or water vapor include, but not limited to, a method of soaking in a water bath, a method of spraying water, and a method of placing in an atmosphere containing water vapor but is preferably a method of placing in an atmosphere containing water vapor. In the method of placing in an atmosphere containing water vapor, the outer layer is allowed to stand still in the air at a temperature of room temperature to 200° C., and preferably room temperature to 100° C., and a relative humidity of 30 to 100%, and preferably 40 to 90%, for 1 minute to 1 month, preferably 1 hour to 1 week, and more preferably 1 to 4 days. More specifically, the outer layer is preferably allowed to stand still in the air at a temperature of 25° C. and a relative humidity of 50% for 72 hours or longer.

Due to the water contact process, a hydrolyzable silyl group (preferably an alkoxysilyl group) in the silane-modified resin in the uncrosslinked resin composition is hydrolyzed to form a silanol group, silanol groups undergo a condensation reaction to form a siloxane bond (Si—O—Si) to crosslink, and thus a crosslinked resin composition is obtained.

The present technology (III) relates to an uncrosslinked resin composition.

An uncrosslinked resin composition of an embodiment of the present technology is an uncrosslinked resin composition containing elastomer having a polyisobutylene backbone and silane-modified resin. A content of the elastomer having a polyisobutylene backbone being 30 mass % or more and 90 mass % or less with respect to a mass of the uncrosslinked resin composition. A content of the silane-modified resin being 10 mass % or more and 70 mass % or less with respect to the mass of the uncrosslinked resin composition. A water vapor permeability after the uncrosslinked resin composition is crosslinked being 2.0 g·mm/(m²·24 h) or less.

The uncrosslinked resin composition refers to a resin composition that is not crosslinked yet. Uncrosslinked indicates that the resin composition has not undergone the water contact process.

The elastomer having a polyisobutylene backbone, the silane-modified resin, and the water vapor permeability are as described above.

The uncrosslinked resin composition crosslinks when brought into contact with water or water vapor, and forms a crosslinked resin composition.

The uncrosslinked resin composition after being crosslinked has a ratio TB₁₀₀/TB₂₅ of the strength at break TB₁₀₀ at 100° C. to the strength at break TB25 at 25° C. of preferably 0.2 or more and 1.0 or less, more preferably 0.3 or more and 1.0 or less, and even more preferably 0.35 or more and 1.0 or less.

“After the uncrosslinked resin composition is crosslinked” means after the uncrosslinked resin composition is adequately crosslinked. The conditions of the crosslinking are not limited as long as adequate crosslinking is allowed and, for example, 1 mass % of a silanol condensation catalyst (silane crosslinking agent master batch PZ010, available from Mitsubishi Chemical Corporation) is added to the uncrosslinked resin composition and the mixture is allowed to stand still in the air at a temperature of 25° C. and a relative humidity of 50% for 72 hours.

Adequate crosslinking means that a fluctuation of the TB 100 of the silane-modified resin per 1 hour of crosslinking time is within 10%, which is a steady state.

### EXAMPLES

### Raw Materials

The raw materials used in the following examples and comparative examples are as follows.

IIR: Butyl rubber “Exxon Butyl” 268, available from ExxonMobil Chemical Co.

Br-IIR: Brominated butyl rubber “Exxon Bromobutyl” 2255, available from ExxonMobil Chemical Co.

PP/EPDM: PP/EPDM thermoplastic elastomer “Santoprene” (trade name) 111-35, available from ExxonMobil Japan G.K.

Rubber crosslinking agent: Alkylphenol-formaldehyde resin “Hitanol” (trade name) 2501Y, available from Hitachi Chemical Co., Ltd.

ZnO: Zinc Oxide III, available from Seido Chemical Industry Co., Ltd. Silane-modified resin: Silane-modified polypropylene “Linklon” (trade name) XPM800HM, available from Mitsubishi Chemical Corporation

PP: Propylene homopolymer “Prime Polypro” (trade name) J108M, available from Prime Polymer Co., Ltd.

Anti-aging agent: Hindered phenol-based antioxidant “IRGANOX” (trade name) 1010, available from BASF Japan Ltd.

Silanol condensation catalyst: Silane crosslinking agent master batch “Catalyst MB” PZ010, available from Mitsubishi Chemical Corporation

### Examples 1 to 5 and Comparative Example 1

The raw materials were charged into a twin screw extruder (available from The Japan Steel Works, Ltd.) at the compounding ratios shown in Table 1, and kneaded for 3 minutes at 235° C. The kneaded product was extruded continuously in a strand-like form from the twin screw extruder, cooled with water, and then cut with a cutter to obtain a pellet-shaped resin composition.

For the obtained resin composition, the water vapor permeability, flexibility, extrudability, and strength at break at 25° C. and 100° C. were measured and evaluated. The measurement and evaluation results are shown in Table 1.

### Comparative Example 2

Using PP/EPDM thermoplastic elastomer “Santoprene” (trade name) 111-35, available from ExxonMobil Japan G.K., as Comparative Example 2, the water vapor permeability, flexibility, extrudability, and strength at break at 25° C. and 100° C. were measured and evaluated. The measurement and evaluation results are shown in Table 1.

The measurement and evaluation methods are as follows.

### Measurement of Water Vapor Permeability

A sample of the resin composition, in which the silanol condensation catalyst was added, was molded into a sheet with an average thickness of 0.2 mm by using a 40 mmφ single screw extruder (available from Pla Giken Co., Ltd.) equipped with a 550-mm wide T-shaped die and setting the temperatures of the cylinder and the die at 10° C. plus the melting point of the polymer component having the highest melting point in the sample composition at a cooling roll temperature of 50° C. and a take-up speed of 3 m/min.

The obtained sheet was crosslinked by being allowed stand still in the air at a temperature of 25° C. and a relative humidity of 50% for 72 hours, and then measured at a temperature of 60° C. and a relative humidity of 95% using a water vapor permeability tester, available from GTR Tec Corporation.

The water vapor permeability is an indicator of water vapor barrier properties, and a smaller water vapor permeability indicates superior water vapor barrier properties.

### Evaluation of Flexibility

The crosslinked sheet having an average thickness of 0.2 mm prepared for measurement of the water vapor permeability was punched out into a JIS No. 3 dumbbell shape and subjected to tensile tests in a condition at a temperature of 25° C. and a rate of 500 mm/min in accordance with the measurement method specified in JIS K 6251 “Rubber, vulcanized or thermoplastic-Determination of tensile stress-strain properties”. Based on the obtained stress-strain curve, a stress at 10% elongation (10% modulus) was determined.

The 10% modulus is an indicator of flexibility, and a smaller 10% modulus indicates superior flexibility. The flexibility is evaluated as pass when the 10% modulus is 10 MPa or less, and evaluated as failure when the 10% modulus is greater than 10 MPa.

### Evaluation of Extrudability

A sample of the resin composition, in which the silanol condensation catalyst was added, was molded into a sheet with an average thickness of 0.2 mm by using a 40 mmφ single screw extruder (available from Pla Giken Co., Ltd.) equipped with a 550-mm wide T-shaped die and setting the temperatures of the cylinder and the die at 10° C. plus the melting point of the polymer component having the highest melting point in the sample composition at a cooling roll temperature of 50° C. and a take-up speed of 3 m/min. The thickness of each of the films was 0.2 mm, and a case where molding had no problem was evaluated as “∘”, a case where slight lump or hole or cutting of a sheet edge occurred was evaluated as “Δ”, and a case where serious lump or hole or cutting of a sheet edge occurred was evaluated as “x”.

### Measurement of Strength at Break

The sheet having the average thickness of 0.2 mm produced in the measurement of water vapor permeability was allowed to stand still in the air at a temperature of 25° C. and a relative humidity of 50% for 72 hours or longer, and thus a sheet of the crosslinked resin composition was produced. The sheet of the crosslinked resin composition was punched out into a JIS No. 3 dumbbell shape and subjected to tensile tests in a condition at a temperature of 25° C. and a rate of 500 mm/min and in a condition at a temperature of 100° C. and a rate of 500 mm/min in accordance with the measurement method specified in JIS K 6251 “Rubber, vulcanized or thermoplastic-Determination of tensile stress-strain properties”. Based on the obtained stress-strain curve, a stress at break (strength at break) was determined.

Taking the strength at break at 25° C. as TB₂₅ and the strength at break at 100° C. as TB₁₀₀, a ratio TB₁₀₀/TB₂₅ was calculated. The TB₁₀₀/TB₂₅ is an indicator of heat resistance, and a TB₁₀₀/TB₂₅ closer to 1.0 indicates superior heat resistance.

TABLE 1

| | | Example | Example | Example | Example |
|---|---|---|---|---|---|
| | | 1 | 2 | 3 | 4 |
| IIR | Parts by mass | 48 | 68 | 68 | 70 |
| BR-IIR | Parts by mass | | | | |
| PP/EPDM | Parts by mass | | | | |
| Rubber | Parts by mass | 1 | 1 | 1 | 1 |
| crosslinking | | | | | |
| agent | | | | | |
| ZnO | Parts by mass | | | | |
| Silane- | Parts by mass | 47 | 13 | 27 | 28 |
| modified | | | | | |
| resin | | | | | |
| PP | Parts by mass | | 13 | | |
| Anti-aging | Parts by mass | 2 | 3 | 3 | |
| agent | | | | | |
| Silanol | Parts by mass | 2 | 2 | 1 | 1 |
| condensation | | | | | |
| catalyst | | | | | |
| Total | Parts by mass | 100 | 100 | 100 | 100 |
| Water vapor | g · mm/(m² · 24 h) | 1.5 | 1.5 | 1.8 | 1.8 |
| permeability | | | | | |
| Flexibility | | Pass | Pass | Pass | Pass |
| Extrudability | | ◯ | ◯ | ◯ | Δ |
| TB₁₀₀ | MPa | 7.4 | 3.5 | 2.7 | 2.7 |
| TB₂₅ | MPa | 17.7 | 9.2 | 6.5 | 6.5 |
| TB₁₀₀/TB₂₅ | | 0.42 | 0.38 | 0.42 | 0.42 |

| | | Example | Comparative | Comparative |
|---|---|---|---|---|
| | | 5 | Example 1 | Example 2 |
| IIR | Parts by mass | 72 | | |
| BR-IIR | Parts by mass | | 69 | |
| PP/EPDM | Parts by mass | | | 100 |
| Rubber | Parts by mass | 1 | | |
| crosslinking | | | | |
| agent | | | | |
| ZnO | Parts by mass | | 2 | |
| Silane- | Parts by mass | 23 | | |
| modified | | | | |
| resin | | | | |
| PP | Parts by mass | | 29 | |
| Anti-aging | Parts by mass | 3 | | |
| agent | | | | |
| Silanol | Parts by mass | 1 | | |
| condensation | | | | |
| catalyst | | | | |
| Total | Parts by mass | 100 | 100 | 100 |
| Water vapor | g · mm/(m² · 24 h) | 1.9 | 1.7 | 14.1 |
| permeability | | | | |
| Flexibility | | Pass | Pass | Pass |
| Extrudability | | ◯ | ◯ | ◯ |
| TB₁₀₀ | MPa | 2.3 | 1.2 | 0.8 |
| TB₂₅ | MPa | 5.4 | 8 | 1.7 |
| TB₁₀₀/TB₂₅ | | 0.42 | 0.15 | 0.47 |

The resin composition of an embodiment of the present technology can be suitably used as a raw material to produce a molded product that requires flexibility, heat resistance, and water vapor barrier properties, such as a refrigerant-transporting hose.

1. A resin composition containing elastomer having a polyisobutylene backbone and silane-modified resin,
a content of the elastomer having a polyisobutylene backbone being 30 mass % or more and 90 mass % or less with respect to a mass of the resin composition,
a content of the silane-modified resin being 10 mass % or more and 70 mass % or less with respect to the mass of the resin composition,
a water vapor permeability of the resin composition being 2.0 g·mm/(m²·24 h) or less, and
a ratio TB₁₀₀/TB₂₅ of a strength at break TB₁₀₀ of the resin composition at 100° C. to a strength at break TB₂₅ of the resin composition at 25° C. being 0.2 or more and 1.0 or less.

2. The resin composition according to claim 1, wherein the silane-modified resin is resin obtained by modifying polyolefin-based thermoplastic resin with a silane compound.

3. The resin composition according to claim 1, wherein the silane-modified resin is silane-modified polypropylene.

4. The resin composition according to claim 1, wherein the resin composition contains a silanol condensation catalyst.

5. The resin composition according to claim 1, wherein the elastomer having a polyisobutylene backbone is butyl rubber or modified butyl rubber.

6. The resin composition according to claim 1, wherein the elastomer having a polyisobutylene backbone is dynamically crosslinked.

7. The resin composition according to claim 1, wherein the resin composition contains 1 mass % or more and 4 mass % or less of an anti-aging agent with respect to the mass of the resin composition.

8. The resin composition according to claim 1, wherein
the resin composition has an islands-in-the-sea structure composed of a matrix containing the silane-modified resin and a domain containing the elastomer having a polyisobutylene backbone dispersed in the matrix, and
the matrix is crosslinked.

9. A method for producing the resin composition according to claim 1, the method comprising:
preparing an uncrosslinked resin composition by melt-kneading elastomer having a polyisobutylene backbone and silane-modified resin; and
adding a silanol condensation catalyst to an uncrosslinked resin composition during molding to mold the uncrosslinked resin composition.

10. The method according to claim 9, further comprising
after the step of adding a silanol condensation catalyst to an uncrosslinked resin composition during molding to mold the uncrosslinked resin composition, producing a crosslinked resin composition by bringing the uncrosslinked resin composition molded into contact with water or water vapor.

11. An uncrosslinked resin composition containing elastomer having a polyisobutylene backbone and silane-modified resin,
a content of the elastomer having a polyisobutylene backbone being 30 mass % or more and 90 mass % or less with respect to a mass of the uncrosslinked resin composition,
a content of the silane-modified resin being 10 mass % or more and 70 mass % or less with respect to the mass of the uncrosslinked resin composition, and
a water vapor permeability after the uncrosslinked resin composition is crosslinked being 2.0 g·mm/(m²·24 h) or less.

12. The uncrosslinked resin composition according to claim 11, wherein after the uncrosslinked resin composition is crosslinked, a ratio TB₁₀₀/TB₂₅ of a strength at break TB₁₀₀ at 100° C. to a strength at break TB25 at 25° C. is 0.2 or more and 1.0 or less.

13. The resin composition according to claim 2, wherein the silane-modified resin is silane-modified polypropylene.

14. The resin composition according to claim 13, wherein the resin composition contains a silanol condensation catalyst.

15. The resin composition according to claim 14, wherein the elastomer having a polyisobutylene backbone is butyl rubber or modified butyl rubber.

16. The resin composition according to claim 15, wherein the elastomer having a polyisobutylene backbone is dynamically crosslinked.

17. The resin composition according to claim 16, wherein the resin composition contains 1 mass % or more and 4 mass % or less of an anti-aging agent with respect to the mass of the resin composition.

18. The resin composition according to claim 17, wherein
the resin composition has an islands-in-the-sea structure composed of a matrix containing the silane-modified resin and a domain containing the elastomer having a polyisobutylene backbone dispersed in the matrix, and
the matrix is crosslinked.

19. A method for producing the resin composition according to claim 18, the method comprising:
preparing an uncrosslinked resin composition by melt-kneading elastomer having a polyisobutylene backbone and silane-modified resin; and
adding a silanol condensation catalyst to an uncrosslinked resin composition during molding to mold the uncrosslinked resin composition.

20. The method according to claim 19, further comprising
after the step of adding a silanol condensation catalyst to an uncrosslinked resin composition during molding to mold the uncrosslinked resin composition, producing a crosslinked resin composition by bringing the uncrosslinked resin composition molded into contact with water or water vapor.
